(19) United States
(12) Patent Application Publication
(10) Pub. No.: US 2007/0221722 A1
(43) Pub. Date: Sep. 27, 2007

(54) Information guide

(76) Inventor: Rodney Wayne, St. George, UT (US)

Correspondence Address: CLIFFORD B. VATERLAUS;CLAYTON, HOWARTH & CANNON, P.C., P.O. BOX 1909, SANDY, UT, 84091, US

(21) Appl. No.: 11/786,043

(22) Filed: Apr. 9, 2007

Related U.S. Application Data
(63) Continuation-in-part of application No. 11/508,737, filed on Aug. 22, 2006, now abandoned.
(60) Provisional application No. 60/710,437, filed on Aug. 22, 2005.

(51) Int. Cl. G06G 1/14

(52) U.S. Cl. 235/61 B

(57) ABSTRACT

A method and device for providing information for use in medical procedures such as rapid sequence intubation. The device may include a cover and a slide. The cover may include a listing of types of equipment and medications, whereas the slide may include equipment specifications and dosage information corresponding to a particular weight of a patient. The slide may be moved with respect to the cover to display the weight of a patient through a first window. The proper equipment specifications and dosages listed on the slide may then be displayed through the cover. Accordingly, proper equipment sizes and dosages may be easily determined. One side of the device may include information pertaining to adult populations, whereas the opposite side of the cover may include information pertaining to pediatric populations.

### CROSS-REFERENCE TO RELATED APPLICATIONS

This application is a continuation-in-part of co-pending U.S. patent application Ser. No. 11/508,737, filed Aug. 22, 2006, entitled “Information Guide,” which application claims the benefit of U.S. Provisional Application No. 60/710,437, filed Aug. 22, 2005, entitled “Information Guide,” which applications are hereby incorporated by reference herein in their entireties, including but not limited to those portions that specifically appear hereinafter, the incorporation by reference being made with the following exception: In the event that any portion of the above-referenced applications is inconsistent with this application, this application supercedes said above-referenced applications.

### STATEMENT REGARDING FEDERALLY SPONSORED RESEARCH OR DEVELOPMENT

Not Applicable.

### BACKGROUND

1. The Field of the Invention

The present disclosure relates generally to methods and devices for providing information, and more particularly, but not necessarily entirely, to a device for quickly determining equipment to be used and/or dosages of medication to be administered for medical procedures such as rapid sequence intubation.

2. Description of Related Art

Healthcare providers are commonly required to determine proper dosages of medication and equipment sizes for patients. During emergency situations, healthcare providers may be required to determine such medication dosages and equipment sizes quickly and accurately to ensure proper treatment of patients. Often medical procedures require multiple medications and pieces of equipment, thereby making the proper treatment of patients more difficult under emergency conditions.

For example, rapid sequence intubation (RSI) is an important technique for airway management of patients in the healthcare field. RSI may be defined as a technique where a potent sedative or induction agent is administered with a paralyzing dose of a neuromuscular blocking agent to facilitate rapid tracheal intubation (the insertion of a tube into the trachea). RSI may be used in various situations, such as, for example, when a patient has an airway obstruction, when a patient has inadequate central nervous system control of ventilation, or when a patient is experiencing excessive work in breathing which may lead to fatigue and respiratory failure. The RSI technique may include specific protection against aspiration of gastric contents, provide excellent access to the airway for intubation, and may permit pharmacologic control of adverse responses to illness, injury, and the intubation itself.

Various different medications may be administered during the RSI technique, each of which must be administered in a proper dosage. For example, medications including vecuronium, atropine, lidocaine, etomidate, midazolam, ketamine, succinylcholine, rocuronium, and vecuronium may be administered during the RSI procedure. Similarly, the equipment used in the RSI technique, such as an endotrachial tube (ETT) or a laryngeal mask airway (LMA) must be properly sized for each particular patient. Prior art methods for determining the proper dosage of each of the medications and the proper size of equipment to use has required multiple steps, involving various different charts and calculations. Accordingly, it has been difficult for healthcare professionals to calculate the proper dosage for each particular medication and the proper size for each piece of equipment required in an emergency situation with speed and accuracy.

Despite the advantages of known systems and methods for providing information for use in performing emergency medical procedures, improvements are still being sought. The prior art is thus characterized by several disadvantages that are addressed by the present disclosure. The present disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a first side view of an information guide device made in accordance with the principles of the present disclosure;

FIG. 2 is a second side view of the information guide device of FIG. 1;

FIG. 3 is a side view of the information guide device of FIG. 1 with a slide portion extended;

FIG. 4 is a first side view of a slide portion of the guide of FIG. 1;

FIG. 5 is a second side view of the slide portion of FIG. 4; and

FIG. 6 is a flowchart showing exemplary method steps for use with the information guide of FIG. 1.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present apparatus and methods for providing information are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by the appended claims and equivalents thereof.

It must be noted that, as used in this specification and the appended claims, the singular forms “a,” “an,” and “the” include plural referents unless the context clearly dictates otherwise. Moreover, as used herein, the terms “comprising,” “including,” “containing,” “characterized by,” and grammatical equivalents thereof are inclusive or open-ended terms that do not exclude additional, unrecited elements or method steps.

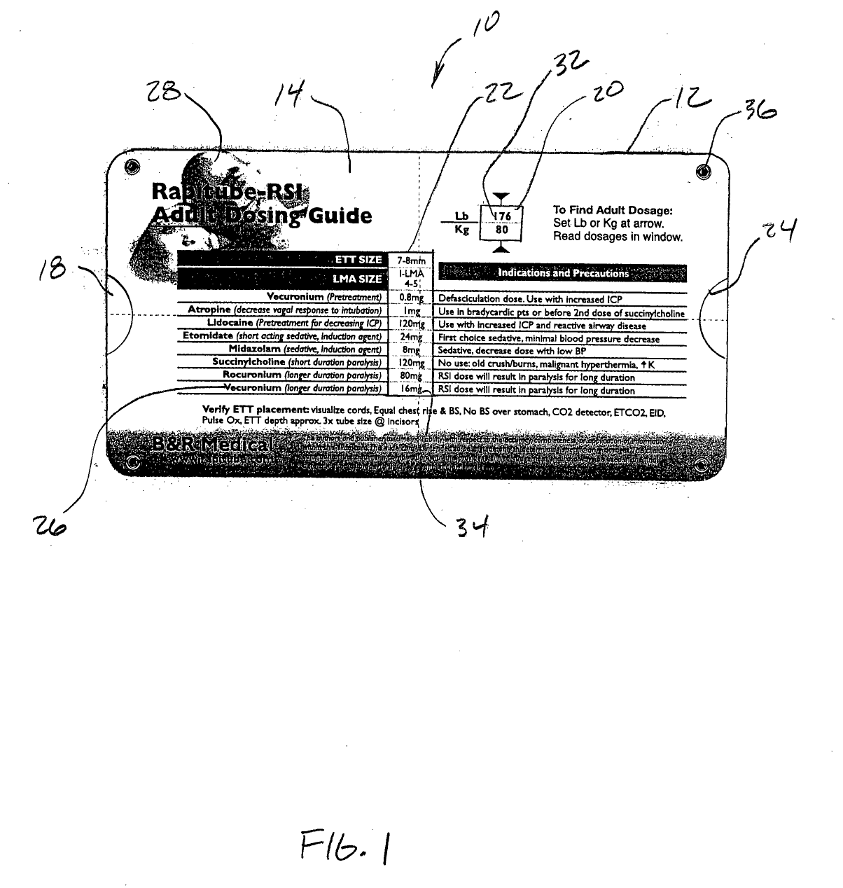

Referring now to FIG. 1, a side view is shown of an information guide device, indicated generally at 10, made in accordance with the principles of the present disclosure. One embodiment of the information guide 10 may be rectangular in shape. However, it will be understood that the information guide 10 may have various different shapes within the scope of the present disclosure.

The information guide 10 may be sized having a width that may be suitable to be held in a health care professional's hand. For example, one edge of the width may be held with the fingers, and the opposing width edge may be held with the thumb, such that a front side of the guide 10 may be visible. However, it will be understood that the information guide may be configured in any suitable size within the scope of the present disclosure.

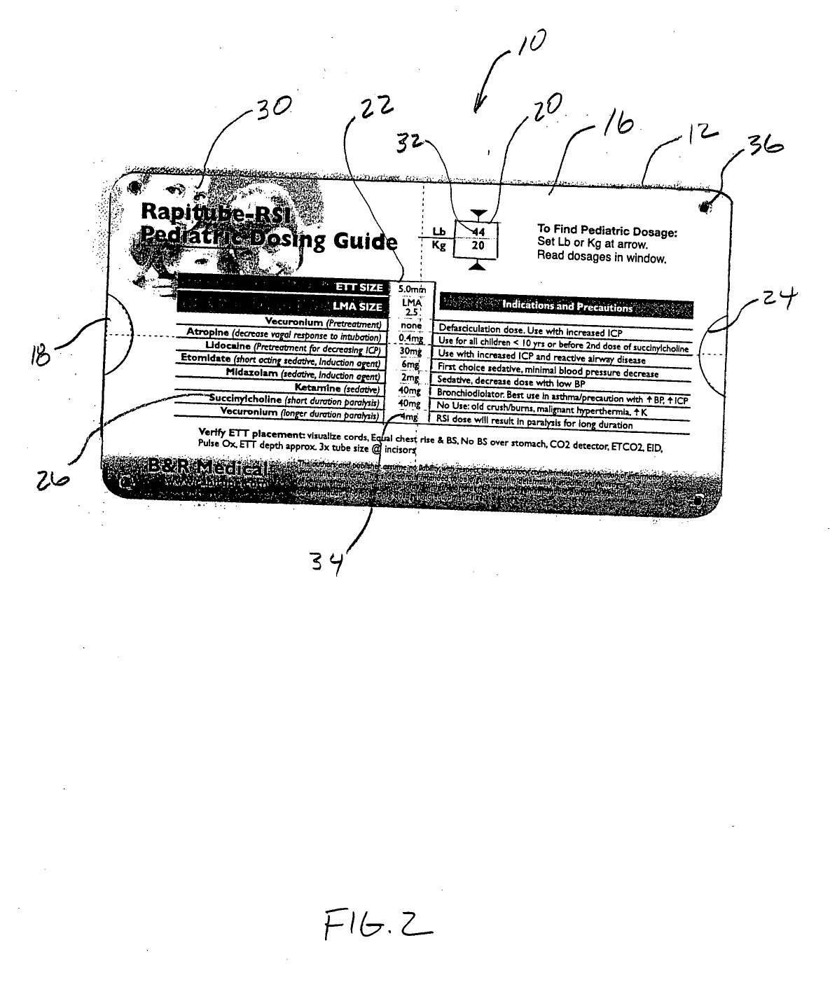

The information guide 10 may include a cover 12 defining a first side 14 and a second side 16, as shown in FIG. 2. The cover 12 may receive a slide 18 between the first side 14 and the second side 16. The slide 18 may be movable with respect to the cover 12 to display information as discussed more fully below.

The cover 12 may include a first window 20 for displaying information that may be placed on the slide 18, such as a weight value, for example. It will be understood that the second side 16 may also include a first window 20. The cover 12 may also include a second window 22 for displaying information that may be located on the slide 18, such as equipment size information and/or pre-calculated medication dosage information. It will be understood that some embodiments of the present disclosure may include the first window 20 spaced apart from the second window 22, whereas other embodiments of the present disclosure may include the first window 20 joining the second window 22 so as to form a single window. Moreover, other embodiments of the present disclosure may have different quantities of windows in various different locations within the scope of the present disclosure.

The cover 12 may also include one or more recesses 24 such that the slide 18 may be easily accessible to be grasped and adjusted by pulling or pushing the slide 18 to a desired position with respect to the cover 12. One embodiment of the present disclosure may include recesses on opposing ends of the cover 12. Moreover, the cover may include data 26 such as medications, types of equipment, instructions and/or other such information useful for a particular purpose.

One embodiment of the present disclosure may include a cover 12 in which the first side 14 may have information pertaining to an adult population, and the second side 16 may have information pertaining to a pediatric population. The first side 14 may also include visual indicators of adults 28, whereas the second side 16 may include visual indicators of children 30. This may assist healthcare providers in obtaining correct information rapidly for both adult populations and pediatric populations. It will be understood that various different visual indicators may be utilized to assist in distinguishing the first side 14 of the cover 12 from the second side 16 of the cover 12. For example, the visual indicators of adults 28 may include depictions of adults, whereas the visual indicators of children 30 may include depictions of children. However, it will be understood that various other depictions or words representing adults and children may be used within the scope of the present disclosure. Moreover, other embodiments of the information guide 10 may have information pertaining to adult or pediatric populations on both sides, or any other classifications or groupings in place of adult or pediatric populations.

It will also be appreciated that the first side 14 of the cover 12 may be colored differently than the second side 16, to further assist in distinguishing one side of the cover 12 from another. For example, the first side 14 of the cover 12 may be red, and the second side of the cover 12 may be blue, such that those using the information guide 10 can readily distinguish one side from the other. It will be understood that various different colors may be used within the scope of the present disclosure, and that some embodiments of the present disclosure may include covers 12 having the same colors on both sides of the cover 12.

In one embodiment of the present disclosure, the data 26 on the cover 12 may include equipment specifications for items useful for RSI procedures such as endotrachial tube (ETT) size and laryngeal mask airway (LMA) size. It will be understood that various other equipment types may be presented on the cover 12 for corresponding to information on the slide 18. Similarly, the data 26 on the cover 12 may include medications commonly used in the RSI procedure including pretreatment medications such as vecuronium, atropine and lidocaine; sedative medications, such as etomidate, midazolam, ketamine; and induction/paralytic medications, such as succinylcholine, rocuronium, and vecuronium. It will be understood that various different combinations of medications may be used within the scope of the present disclosure. For example, the cover 12 corresponding to pediatric populations may include the medications mentioned above except rocuronium. Similarly, the medications used for adult populations may include those listed above except ketamine. It will also be understood that additional medications may be utilized, or that not all of the above listed medications may be utilized in some embodiments. Moreover, some embodiments of the present disclosure may have different medications replacing one or more of the above mentioned medications for use with the RSI procedure. Also, other data such as descriptions of indications and precautions may be presented on the cover 12. Additionally, other embodiments of the present disclosure may be used for procedures other than the RSI procedure such that the equipment and medications listed may vary depending on the particular use.

The slide 18 may include a listing of weights 32 of patients. One embodiment of the present disclosure may include weights 32 in both pounds and kilograms. Alternative embodiments may include weights in only pounds or kilograms. It will also be understood that any other suitable unit of measurement may be used within the scope of the present disclosure. Moreover, other information, such as age or size, for example, may be used in connection with the slide 18, as a basis for determining corresponding information.

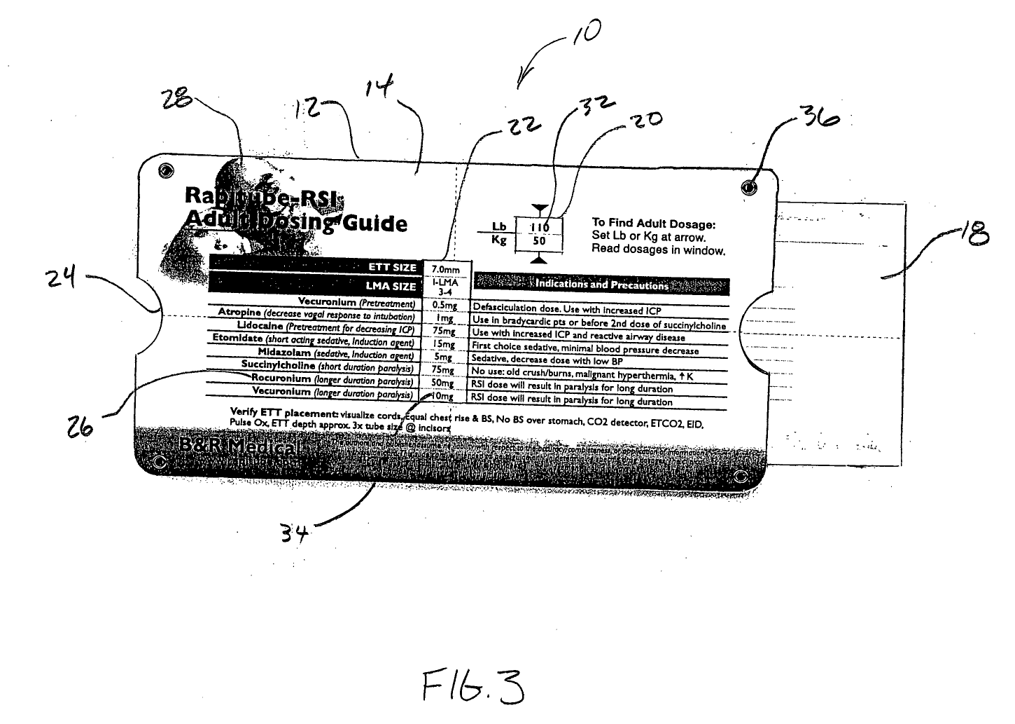

The slide 18 may also include a listing of information 34 corresponding to the weight 32. For example, the information 34 may include equipment specifications and medication dosages corresponding to a patient weight in accordance with the data 26 listed on the cover 12. Accordingly, in use, a patient's weight may be determined or estimated and the slide 18 may be moved until the patients weight 32 is shown in the first window 20. The data 26 listed on the cover 12, and the information 34 on the slide 18 may be arranged such that the information 34 corresponding to the data 26 may be in alignment in the second window 22. This may allow a user to easily and quickly correlate the information 34, such as dosage, with the data 26, such as the type of medication. One embodiment of the information guide 10 with the slide 18 extended is shown in FIG. 3. The appropriate equipment specifications and medication dosages may be displayed in the second window 22 such that a medical professional can easily, quickly and accurately determine the proper equipment sizes and medication dosages for a particular patient. Thus the chance of error may be significantly reduced in emergency situations, such as during RSI procedures. This may be particular beneficial during RSI procedures, since RSI procedures are often done under emergency conditions, and RSI procedures require the administration of multiple medications.

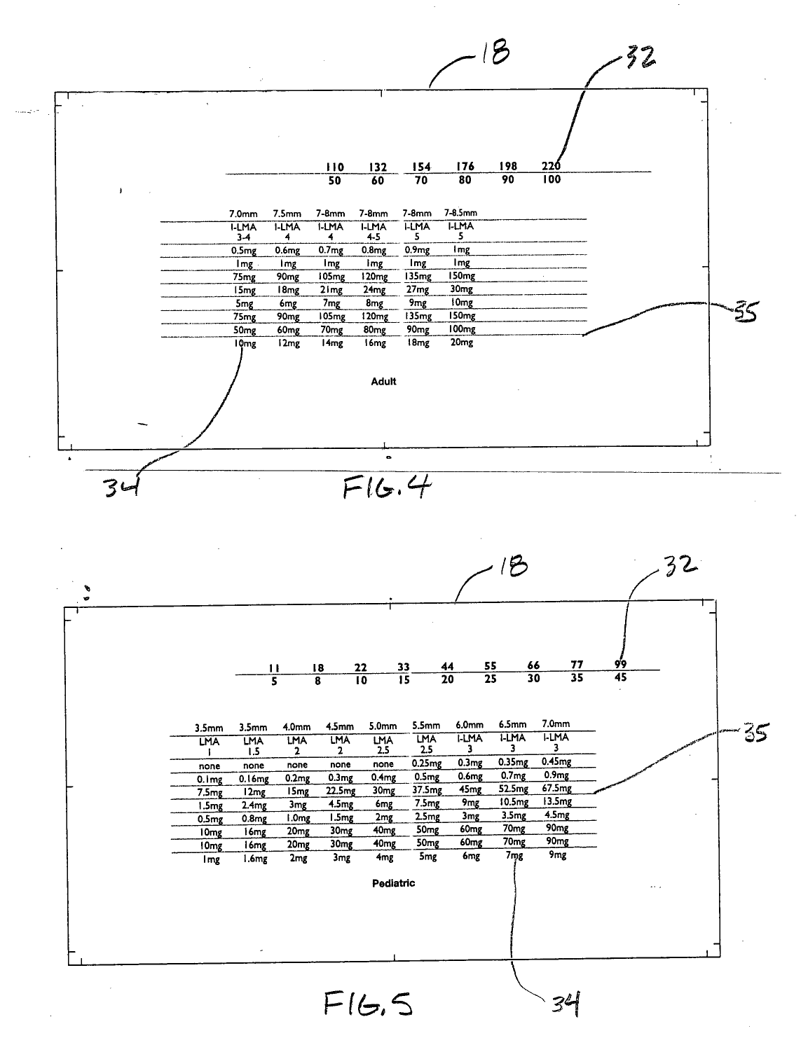

One embodiment of the slide 18 is depicted in FIGS. 4 and 5, in which FIG. 4 depicts weights 32 and information 34 pertaining to adult populations, and FIG. 5 depicts weights 32 and information 34 pertaining to pediatric populations. It will be understood that the slide 18 may be formed of a single piece with the data shown in FIG. 4 on one side, and the data shown in FIG. 5 on the opposite side. It will also be understood that the slide 18 depicted in FIGS. 4 and 5 may be sized as desired to fit within the cover, and the slide 18 depicted in FIGS. 4 and 5 is for illustrative purposes only. Moreover, stops (not shown) may be formed on the slide 18 for contacting an attachment mechanism 36, for example, to limit the movement of the slide 18 within the cover 12, or to prevent the slide 18 from being removed from the cover 12.

It will be understood that the information 34 may be arranged in a plurality of rows and columns. Markings 35, such as lines, may be used to separate the information into rows to facilitate aligning the information 34 with the data 26 on the cover 12. Alternative embodiments may have the rows designated by shading or different colors to facilitate aligning the information 34 with the data 26 on the cover. Other embodiments of the slide 18 may be formed without the markings 35.

It will be understood that the weight 32 may include a plurality of values configured to correspond to different sets of information 34. Accordingly, the more frequently the information 34 changes with respect to the weight 32, the more weight 32 values may be used to achieve accurate results. For example, pediatric information 34 may change with relatively minor changes in weight of the patient such that more values for weights 32 and information 34 may be used as compared to weights 32 and information 34 useful for adults. In the example shown in FIGS. 4 and 5, adult values may include six sets of weight 32 values and corresponding information 34 on the slide 18, whereas for pediatric uses, the slide 18 may include nine sets of weight 32 values and corresponding information 34. It will be appreciated that various different quantities of weights 32 and information 34 may be used within the scope of the present disclosure.

It will be understood that the weight values 32 may be spaced apart from the information 34 so as to be visible through different portions of the device 10. Alternatively, the weight values 32 may be positioned within the same columns as the information 34. It will also be understood that alternative embodiments of the device 10 may be configured such that the weight 32 values and the information 34 are not arranged in rows and columns on the slide 18.

Other information may be presented on the information guide 10, such as information, instructions, or data including: verify ETT placement, visualize cords, equal chest rise and breath sounds (BS), no BS over stomach, carbon dioxide detector (CO2), end tidal CO2 (ETCO2), esophageal intubation detector (EID), pulse oximetry (pulse OX), and/or endotrachial depth approximately three times the correct tube size at the incisors (ETT depth approximately 3× tube size @incisors), for example. It will be understood that other information may also be placed on the information guide 10 within the scope of the present disclosure.

It will be understood that the information guide 10 may be made of any suitable material known to those skilled in the art. For example, the information guide 10 may be made of a card stock material, metal, or plastic material using manufacturing procedures known in the art. Moreover, the first side 14 of the cover 12 may be joined with the second side 16 of the cover 12 using any suitable attachment mechanism 36 known in the art, such as rivets, fasteners, or adhesives, for example. Also, it will be understood that one embodiment of the present disclosure may include a cover 12 that may be manufactured with the first side 14 integrally formed with the second side 16, such that no attachment mechanism 36 may be required to join the first side 14 and the second side 16. Moreover, another alternative embodiment may be formed without a second side 16. In such embodiment, a groove, strap or other such holding mechanism may be joined to the first side 14 to hold the slide 18 in place with respect to the first side 14.

It will also be understood that additional embodiments may include a cover 12 that may have a rounded or multi-sided cross-sectional shape. The slide 18 may have a shape corresponding to the cover 12 such that the information guide 10 may form a three-dimensional shape, rather than a substantially flat configuration.

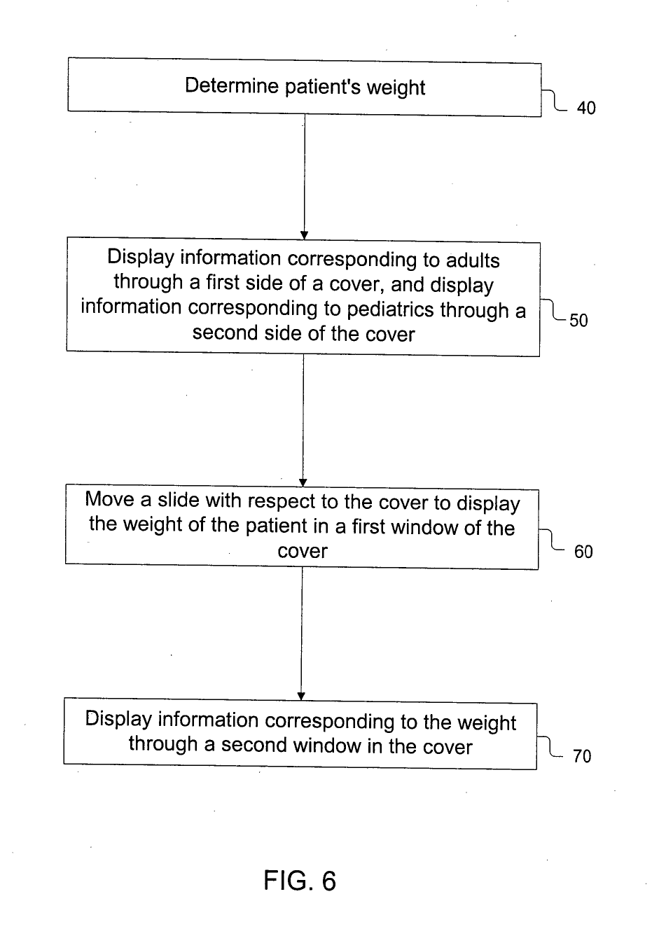

Referring now to FIG. 6, a flow chart is shown depicting method steps that may be useful with the information guide 10. It will be understood that in some embodiments of the present disclosure, not all of the steps depicted in FIG. 6 may be used, and in other embodiments, steps beyond those depicted in FIG. 6 may be used. Moreover, the order of the steps depicted may vary in some embodiments.

One embodiment of a method utilizing the information guide 10 may involve the step 40 of determining a patient's weight. It will be understood that in rapid sequence intubation procedures, the weight of the patient may be estimated by the health care professional since the condition of the patient may not allow the patient to inform the health care professional of his or her weight, and the patient may not be in a condition to be weighed. Moreover, in such emergency conditions, there may not be time or need to determine a precise weight of the patient. However, it will be understood that the weight of the patient may be determined in any suitable manner known to those skilled in the art.

As indicated by reference numeral 50, if the patient is an adult, the health care professional may display relevant information corresponding to adults through a first side 14 of the cover 12. If the patient is a child, the health care professional may display the relevant information corresponding to pediatric uses through a second side 16 of the cover 12. Accordingly, a wide range of uses may be displayed with a single information guide 10.

The health care professional may then move the slide 18 with respect to the cover 12 to display the weight 32 of the patient in a first window 20 of the cover 12, as indicated by the step at reference numeral 60. The slide 18 may be grasped through the recesses 24 in the cover 12 and moved back and forth until the proper weight 32 appears in the first window 20. Labels, directions or other indicia on the cover 12 may facilitate use and reading of the guide 10.

Once the proper weight 32 is indicated in the first window, information 34 corresponding to the weight 32 may be displayed through the second window 22, as indicated by reference numeral 70. The proper dosages and equipment may be quickly and accurately determined in this manner to allow the health care professional to initiate a medical procedure such as rapid sequence intubation.

The information guide 10 and methods disclosed herein may be particularly useful for rapid sequence intubation procedures, since such procedures require the determination of equipment sizes and proper dosages for a number of different types of medications in high stress, emergency situations. Time is of the essence in such situations, and the accuracy of the information is crucial to the well being of the patient.

The information guide 10 may be attached to a cord and to a cart or other equipment used when performing rapid sequence intubation procedures so that the guide 10 may be easily accessible when needed. Also, the information guide 10 may be sized and configured to fit in a pocket, or clip board, for example, such that the guide 10 may be stored in a location for easy access.

It will be appreciated that the structure and apparatus disclosed herein is merely one example of a means for presenting dosage and equipment information for use in rapid sequence intubation procedures, and it should be appreciated that any structure, apparatus or system for presenting dosage and equipment information that performs functions the same as, or equivalent to, those disclosed herein are intended to fall within the scope of a means for presenting dosage and equipment information, including those structures, apparatus or systems for presenting dosage and equipment information that are presently known, or that may become available in the future. Anything that functions the same as, or equivalently to, a means for presenting dosage and equipment information for use in rapid sequence intubation procedures falls within the scope of this element.

In accordance with the features and combinations described above, a useful method for determining information for use in medical procedures includes the steps of:

determining a weight of a patient;

moving a slide with respect to a cover to display the weight of the patient in a first window of the cover;

displaying said information corresponding to said weight through said cover.

The method may also include the step of displaying dosage and equipment information for use in rapid sequence intubation procedures.

Those having ordinary skill in the relevant art will appreciate the advantages provide by the features of the present disclosure. For example, it is a feature of the present disclosure to provide a method and device for providing information for use in medical procedures that can be used for rapid sequence intubation procedures. Another feature of the present disclosure to provide such a method and device for providing information that is simple in design and operation. It is a further feature of the present disclosure, in accordance with one aspect thereof, to provide a method and device for providing information that can be used quickly and accurately during emergency situations. It is a further feature of the present disclosure to provide a method and device for providing information that can be used for both adult populations and pediatric populations.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A device for providing information for use in medical procedures, said device comprising:
a cover and a slide, said cover and said slide collectively comprising means for presenting dosage and equipment information for use in rapid sequence intubation procedures such that a weight of a patient can be selected to display said dosage and equipment information corresponding to said weight.

2. The device of claim 1, wherein said cover comprises a first side and a second side, said first side and said second side each comprising a first window for displaying said patient weight.

3. The device of claim 2, wherein said first side and said second side each comprise a second window for displaying said dosage and equipment information corresponding to said weight.

4. The device of claim 1, wherein said means for presenting dosage and equipment information comprises a listing of medications on said cover.

5. The device of claim 4, wherein said listing of medications comprises a plurality of medications from the group consisting of vecuronium, atropine, lidocaine, etomidate, midazolam, ketamine, succinylcholine, rocuronium, and vecuronium.

6. The device of claim 1, wherein said means for presenting dosage and equipment information comprises a listing of equipment on said cover.

7. The device of claim 6, wherein said listing of equipment comprises endotrachial tube size and laryngeal mask airway size.

8. The device of claim 1, wherein said means for presenting dosage and equipment information comprises a listing of dosages on said slide.

9. The device of claim 1, wherein said means for presenting dosage and equipment information comprises a listing of equipment specifications on said slide.

10. The device of claim 1, wherein said slide comprises a plurality of weight values in pounds and kilograms.

11. The device of claim 1, wherein said cover comprises a first side and a second side, said first side and said second side each comprising a first window for displaying said patient weight;
wherein said first side and said second side each comprise a second window for displaying said dosage and equipment information corresponding to said weight;
wherein said means for presenting dosage and equipment information comprises a listing of medications on said cover;
wherein said listing of medications comprises a plurality of medications from the group consisting of vecuronium, atropine, lidocaine, etomidate, midazolam, ketamine, succinylcholine, rocuronium, and vecuronium;
wherein said means for presenting dosage and equipment information comprises a listing of equipment on said cover;
wherein said listing of equipment comprises at least one of a group consisting of endotrachial tube size and laryngeal mask airway size;
wherein said means for presenting dosage and equipment information comprises a listing of dosages on said slide;
wherein said means for presenting dosage and equipment information further comprises a listing of equipment specifications on said slide;
wherein said slide comprises a plurality of weight values in pounds and kilograms, said plurality of weight values being positioned to be displayed through said first window;
wherein said listing of dosages is arranged on said slide in a plurality of rows and columns;
wherein said cover comprises at least one recess to facilitate accessing said slide;
wherein said first side comprises visual indicators of adults, and wherein said second side comprises visual indicators of pediatrics.

12. A method for determining information for use in medical procedures, said method comprising:
determining a weight of a patient;
moving a slide with respect to a cover to display the weight of the patient in a first window of the cover;
displaying said information corresponding to said weight through said cover.

13. The method of claim 12, further comprising displaying dosage and equipment information for use in rapid sequence intubation procedures.

14. The method of claim 12, further comprising displaying dosages of a plurality of medications from a group consisting vecuronium, atropine, lidocaine, etomidate, midazolam, ketamine, succinylcholine, rocuronium, and vecuronium.

15. The method of claim 12, further comprising displaying endotrachial tube size and laryngeal mask airway size.

16. The method of claim 12, further comprising displaying said information corresponding to said weight through a second window in said cover.

17. The method of claim 12, further comprising displaying said information corresponding to adults through a first side of said cover, and displaying said information corresponding to pediatrics through a second side of said cover.

18. A method for determining information for use in medical procedures, said method comprising:
arranging a cover having a first side and a second side;
disposing a slide within said cover;
moving said slide within said cover to display information pertaining to adult patients through said first side of said cover, and to display information pertaining to pediatric patients through said second side of said cover.

19. The method of claim 18, further comprising determining a weight of a patient and moving said slide to display said weight through a first window in said cover.

20. The method of claim 18, further comprising displaying dosage and equipment information for use in rapid sequence intubation procedures.
